(19) United States
(12) Patent Application Publication
(10) Pub. No.: US 2026/0361488 A1
(43) Pub. Date: Nov. 12, 2026

(54) Enhanced Data Collection for CSI Compression Modeling

(71) Applicant: Apple Inc., Cupertino, CA (US)

(72) Inventors: Huaning NIU, San Jose, CA (US); Ankit BHAMRI, Haar (DE); Dawei ZHANG, Saratoga, CA (US); Haitong SUN, Saratoga, CA (US); Hong HE, San Jose, CA (US); Oghenekome OTERI, San Diego, CA (US); Sigen YE, San Diego, CA (US); Wei ZENG, Saratoga, CA (US); Weidong YANG, San Diego, CA (US)

(21) Appl. No.: 19/124,073

(22) PCT Filed: Oct. 25, 2023
(86) PCT No.: PCT/US2023/035852

§ 371 Date: Apr. 24, 2025

Related U.S. Application Data
(60) Provisional application No. 63/381,171, filed on Oct. 27, 2022.

(51) Int. Cl. H04L 5/00; H04W 24/08; H04W 28/06

(52) U.S. Cl. CPC H04L 5/0051; H04W 24/08; H04W 28/06

(57) ABSTRACT

A base station configured to send a training channel state information reference signal (CSI-RS) configuration comprising assistance information to a user equipment (UE), wherein the assistance information includes an AI label for training CSI-RS to be measured, send a start indication to the UE to prompt the UE to start measuring the training CSI-RS and receive a measurement report including measurement results for the training CSI-RS.

### PRIORITY/INCORPORATION BY REFERENCE

This application claims priority to U.S. Provisional Application Ser. No. 63/381,171 filed on Oct. 27, 2022 and entitled, “Enhanced Data Collection for CSI Compression Modeling,” the entirety of which is incorporated by reference herein.

### BACKGROUND

Recent 3^{rd} Generation Partnership Project (3GPP) agreements have focused on channel state information (CSI) compression in joint training cases (i.e., encoding/decoding) for use with artificial intelligence (AI) and machine learning (ML) models to enhance CSI feedback behavior in both base stations and user equipment (UE).

Enhancements to model training can be narrowed to three main use cases (i.e., scenarios). Type 1: joint training of a two-sided model at a single side/entity (e.g., user equipment (UE)-sided or network-sided, type 2: joint training of a two-sided model at both the network side and the UE side, and type 3: separate training at the network side and the UE-side, where the UE-side CSI generation part and the network-side CSI reconstruction part are trained by UE side and network side (henceforth split training), respectively.

### SUMMARY

Some example embodiments are related to an apparatus of a base station, the apparatus including processing circuitry configured to configure transceiver circuitry to send a training channel state information reference signal (CSI-RS) configuration comprising assistance information to a user equipment (UE), wherein the assistance information comprises an AI label for training CSI-RS to be measured, configure transceiver circuitry to send a start indication to the UE to prompt the UE to start measuring the training CSI-RS and decode, based on signals received from the UE, a measurement report comprising measurement results for the training CSI-RS.

Other example embodiments are related to an apparatus of a base station, the apparatus including processing circuitry configured to configure transceiver circuitry to send a training sounding reference signal (SRS) configuration to a user equipment (UE), wherein the training SRS configuration comprises training SRS that are to be transmitted via each transmission antenna, decode, based on signals received from each antenna of the UE, training SRS, measure the training SRS and train a CSI compression model based on the training SRS measurements.

Still further example embodiments are related to an apparatus of a user equipment (UE), the apparatus including processing circuitry configured to decode, based on signals received from a base station, a training channel state information reference signal (CSI-RS) configuration comprising assistance information, wherein the assistance information comprises an AI label for training CSI-RS to be measured, measure the training CSI-RS based on the CSI-RS configuration and configure transceiver circuitry to send to the base station, a measurement report comprising measurement results for the training CSI-RS.

Additional example embodiments are related to an apparatus of a user equipment (UE), the apparatus including processing circuitry configured to decode, based on signals received from a base station, a training sounding reference signals (SRS) configuration, wherein the training SRS configuration comprises training SRS that are to be transmitted via each transmission antenna and configure transceiver circuitry to send training SRS based on the training SRS configuration.

### BRIEF DESCRIPTION OF THE DRAWINGS

FIG. 1 shows an example network arrangement according to various example embodiments.

FIG. 2 shows an example UE according to various example embodiments.

FIG. 3 shows an example base station according to various example embodiments.

FIG. 4 shows a first call flow for data collection and joint training at the UE-side according to various example embodiments.

FIG. 5 shows a second call flow for data collection and joint training at the UE-side according to various example embodiments.

FIG. 6 shows a first call flow for data collection and joint training at the network-side according to various example embodiments.

FIG. 7 shows a second call flow for data collection and joint training at the network-side according to various example embodiments.

FIG. 8 shows a first call flow for data collection and joint training at the UE and network-side according to various example embodiments.

FIG. 9 shows a second call flow for data collection and joint training at the UE and network-side according to various example embodiments.

FIG. 10 shows a first call flow for split training occurring at the UE first according to various example embodiments.

FIG. 11 shows a second call flow for split training occurring at the network first according to various example embodiments.

### DETAILED DESCRIPTION

The example embodiments may be further understood with reference to the following description and the related appended drawings, wherein like elements are provided with the same reference numerals. The example embodiments relate to enhanced data collection operations for use in training channel state information (CSI) compression models.

The example embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any electronic component.

The example embodiments are also described with reference to a 5G New Radio (NR) network. However, it should be understood that the example embodiments may also be implemented in other types of networks, including but not limited to LTE networks, future evolutions of the cellular protocol (e.g., 6G networks).

Throughout this description, the term “joint training” is used. It should be understood that joint training means the generation model and reconstruction model may be trained in the same loop for both forward propagation and backward propagation. Joint training may be performed at a single node or across multiple nodes. It should be further understood that separate training includes sequential training starting with UE-side training, or sequential training starting with network-side training, or parallel training at both the UE and network.

It should be understood that throughout this description it will be described that CSI-RS will be transmitted by a base station and measured by a UE. However, as described above, the example embodiments are related to training a CSI compression model. Thus, the CSI-RS that are transmitted and measured are not necessarily the CSI-RS that are typically transmitted by a base station during normal operations, e.g., normal CSI-RS. That is, the CSI-RS that are transmitted may be separate CSI-RS that are transmitted and measured for the purposes of training. These CSI-RS may be referred to as training CSI-RS. However, it should be understood that any reference to CSI-RS in this disclosure may relate to the normal CSI-RS or the training CSI-RS.

Furthermore, while the example embodiments are described with reference to data collection and training of CSI compression models, the example embodiments may be applied to other types of reference signals with respect to data collection and model training.

As described above, the CSI compression models may be trained and used to improve performance of UEs and/or networks. To train the CSI compression models, the UE first performs measurements on CSI reference signals (CSI-RS). These measurements may then be used to train the CSI compression models. However, the CSI-RS measurements may be performed on different CSI-RS and these measurements should be classified in some manner such that the CSI-RS measurements are used to train the correct model. With proper classification, different models can be trained. The example embodiments may provide information that such a classification may be used for the CSI-RS measurements.

The example embodiments are related to enhancements to data collection in three schemes/types (single-entity, dual-entity, and split). In a first aspect, type 1 single-entity may be understood to facilitate UE-side training, validation, and testing of an AI/ML model (version 1), or network-side training, validation, and testing of an AI/ML model (version 2). In a second aspect, type 2 joint training of a two-sided model on both the network-side and the UE-side is described. In a third aspect, type 3 split training is described. The enhancements to each type will be described in greater detail below.

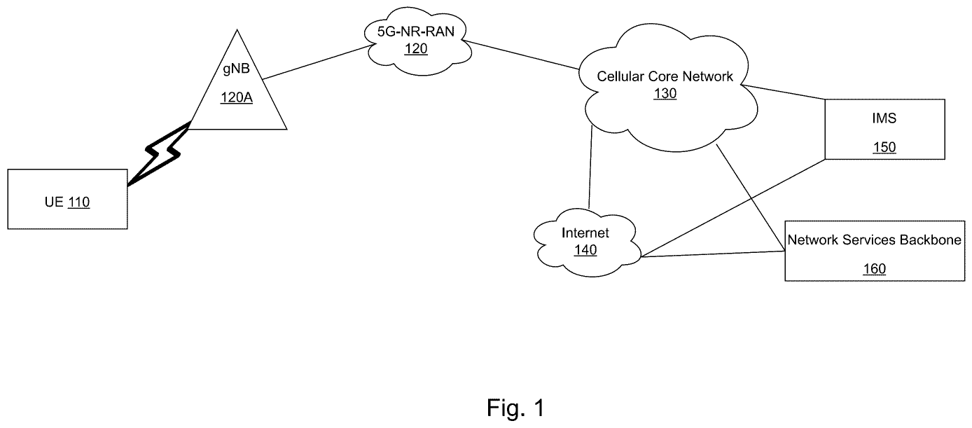

FIG. 1 shows an example network arrangement 100 according to various example embodiments. The example network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., 5G cloud RAN, a next generation RAN (NG-RAN), a legacy cellular network, etc.) and the UE 110 may also communicate with networks over a wired connection. With regard to the example embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

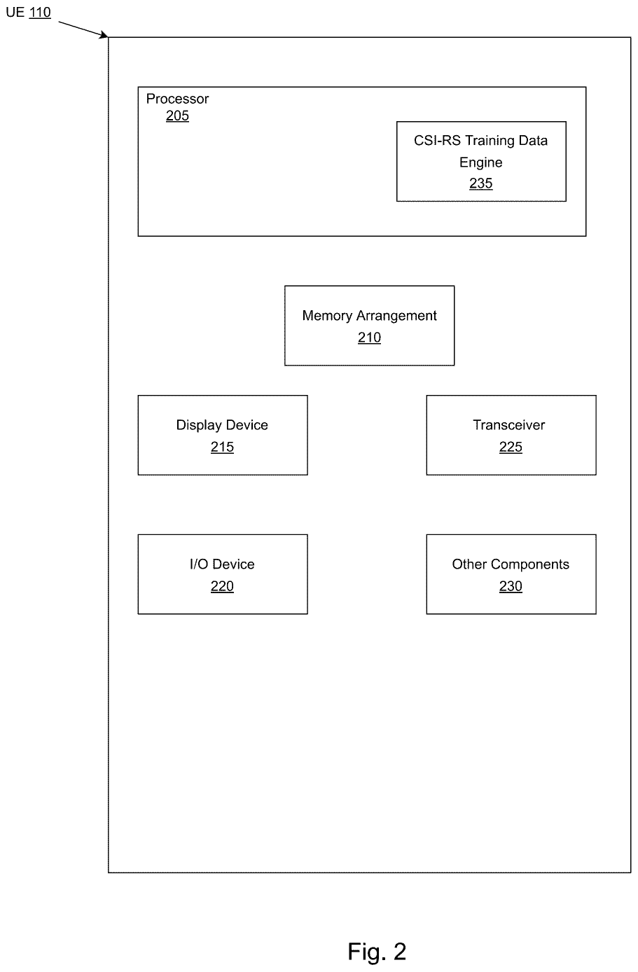

FIG. 2 shows an example UE 110 according to various example embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a CSI-RS training data engine 235 for performing operations such as performing measurements on CSI-RS or SRS and running/generating AI/ML models on measured or received CSI-RS or SRS.

The above referenced engine being an application (e.g., a program) executed by the processor 205 is only example. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UES, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G-NR RAN 120. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

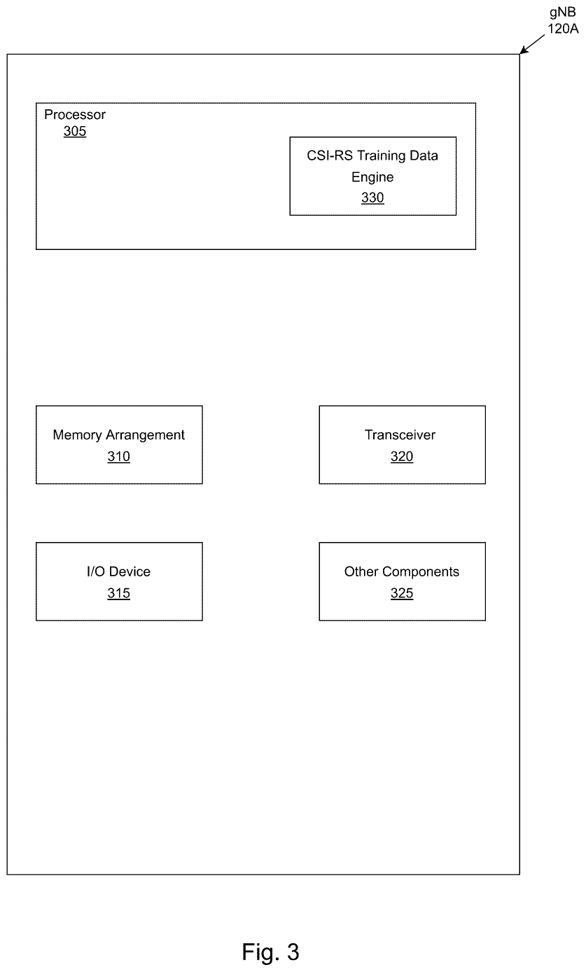

FIG. 3 shows an example base station 300 according to various example embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include a CSI-RS training data engine 330 for performing operations such as performing measurements on CSI-RS or SRS and running/generating AI/ML models on the measured or received CSI-RS or SRS.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

As described above, in a first aspect, type 1 single-entity may be understood to facilitate UE-side training, validation, and testing of an AI/ML model (version 1), or network-side training, validation, and testing of an AI/ML model (version 2).

In a first version of the first aspect of the example embodiments, enhanced data collection for type 1 training at the UE-side is disclosed.

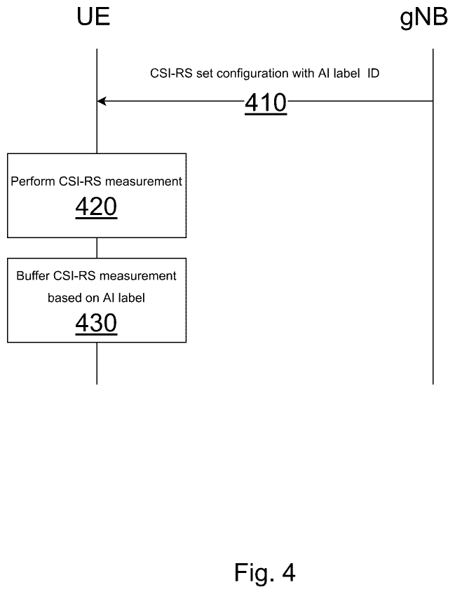

FIG. 4 shows a first call flow for data collection and joint training at the UE-side according to various example embodiments. As described above, classifying the CSI-RS measurements may be useful when the CSI-RS measurements are used for training a model. In a first option of the first version, the network may provide assistance information to the UE 110 when configuring CSI-RS for training purposes. This assistance information may be an AI set identification which is added to a CSI-RS configuration to assist in data collection, e.g., the network provides an AI label for a CSI-RS set for the UE 110 to appropriately store the CSI-RS measurements based on the AI label. In some example embodiments, the AI label may be an AI model identification (ID), where the data collected with the same model ID will be used to train the same CSI compression model.

The classification (e.g., the AI label) may be based on any factor which the network determines is relevant for the model being trained. For example, the network may classify the CSI-RS transmitted by a cell, by an antenna or combination of antennas of a cell, a frequency (or frequency band) of the CSI-RS, a transmission power of the CSI-RS, etc. To provide a simple non-limiting example, there may be two CSI compression models that are being trained, a first CSI compression model related to a first cell and a second CSI compression model related to a second cell. The network may send the UE 110 a CSI-RS configuration that includes the CSI-RS transmitted by the first cell having a first AI label ID and the CSI-RS transmitted by the second cell having a second AI label ID. The UE 110 may make the CSI-RS measurements and store the measurements according to the AI label such that the different CSI-RS measurements may be used to train the corresponding models. It should be understood that the classification (e.g., AI label) being based on the cell transmitting the CSI-RS is only example and any type of classification may be used. Other examples of classifications/labels may include indoor/outdoor/rural/urban, specific network port and channel configurations, etc. Typically, each of these different classification may result in different channel statistic information and thus, may be associated with a different CSI compression model.

In 410, the network (e.g., gNB 120A) transmits a CSI-RS set configuration with an AI label ID to the UE 110. As described above, this AI label ID enables more efficient categorization of the measured CSI-RS by the UE 110. In 420, the UE 110 performs the CSI-RS measurements. In 430, the UE 110 buffers the CSI-RS measurements based on the AI label received from the gNB 120A.

As described above, in these example embodiments the data is being collected for type 1 training at the UE-side. Thus, the UE 110 may then use the CSI-RS measurements having the AI label to train one or more CSI compression models.

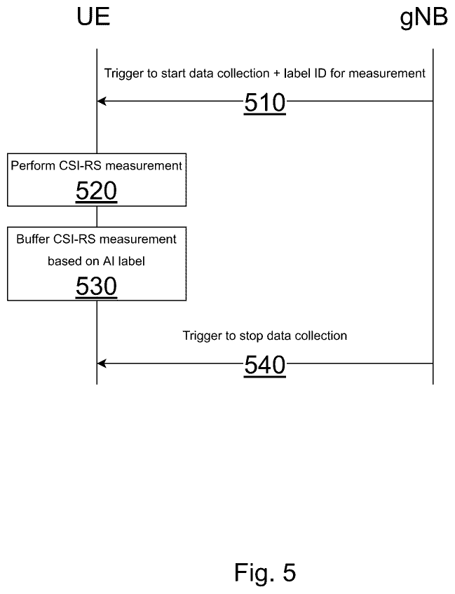

FIG. 5 shows a second call flow for data collection and joint training at the UE-side, according to various example embodiments. In a second option of the first version of the first aspect, the network (e.g., gNB 120A) may indicate a start and stop for data collection and provide the UE 110 with a label ID for the measurement. The UE 110 may then buffer the collected results with a cell ID. The network may provide the UE 110 with assistance information on how to aggregate different data sets based on both the cell ID and the label ID. To provide some further examples of classifications, different data sets measured with different gNB vendors may not be grouped together. Similarly, different antenna panel configurations and virtualization schemes may not be grouped together. In these instances, a different label ID may be assigned.

It should be understood that multiple UEs may provide measurement results to a UE-side server that is used to aggregate the data set(s) from different UEs and then train the model(s). Thus, the UE-side server may receive the assistance information for the purposes of aggregation and model training.

In 510, the gNB 120A transmits a trigger to the UE 110 to begin data collection (i.e., measurements). The trigger 510 may further include a label for the UE 110 to use in categorizing the measurements for further AI/ML training. In 520, the UE 110 performs the CSI-RS measurements. In 530, the UE 110 buffers the CSI-RS measurements based on the received label. In 540, the gNB transmits a trigger to stop data collection to the UE.

As described above, in these example embodiments the data is being collected for type 1 training at the UE-side. Thus, the UE 110 may then use the CSI-RS measurements having a label to train one or more CSI compression models corresponding to the classification related to each label.

In a second version of the first aspect of the example embodiments, enhanced data collection for type 1 training at the network-side is disclosed. In the second version, the network may perform the joint training instead of the UE, as described with respect to the first version and FIGS. 4-5. Those skilled in the art will understand that training the model(s) on the network-side may offer greater computational capacity for model training as compared to the UE-side and may also save battery power of the UE because the UE does not need to perform the computations.

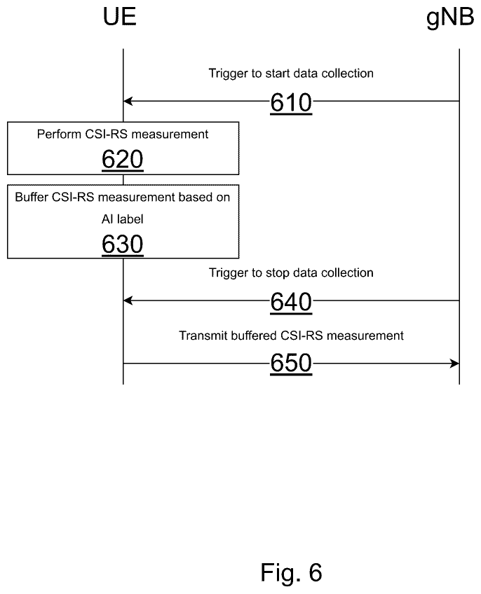

FIG. 6 shows a first call flow for data collection and joint training at the network-side, according to various example embodiments. In 610, the gNB 120A may transmit a trigger to the UE 110 to start data collection. The start trigger 610 may also include a CSI-RS set configuration. The CSI-RS set configuration of start trigger 610 may configure a particular CSI-RS set for AI/ML data collection purposes. The gNB 120A may also configure the data format for data collection (e.g., number of bits per value, channel, eigen vector, etc.).

In 620, the UE 110 performs the CSI-RS measurements based on the received configuration. In some example embodiments, the UE, in 630, buffers the measurement results based on the received label. The buffered CSI-RS measurements may be represented by different quantization, such as 32 bit floating point, 16 bit, etc. In 640, the gNB 120A transmits a trigger for the UE 110 to stop data collection/measurements. In 650, the UE 110 transmits the buffered CSI-RS measurements to the gNB as a data payload via a physical uplink shared channel (PUSCH).

In other example embodiments, after 620, the UE 110 may omit the buffering operation 630. Instead, the UE 110 may transmit measurement results as Uplink Control Information (UCI) for each measurement (e.g., continuously transmitting measurements back as the measurements are created).

As described above, in these example embodiments the data is being collected for type 1 training at the network-side. Thus, the gNB 120A (or other network component) may then use the CSI-RS measurements having a label to train one or more CSI compression models corresponding to the classification related to each label.

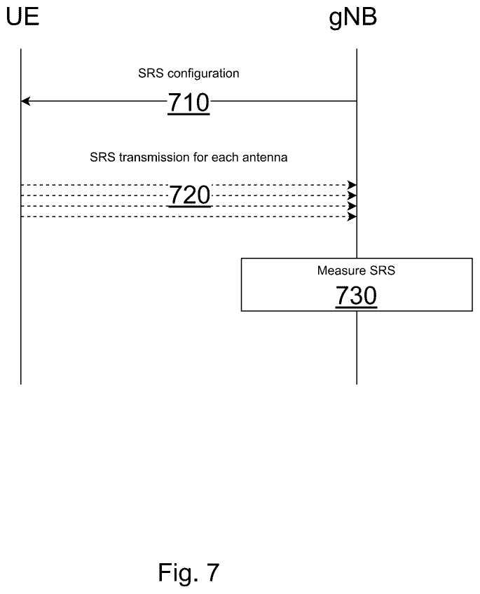

FIG. 7 shows a second call flow for data collection and joint training at the network-side, according to various example embodiments. In a second option of the second version of the first aspect of the example embodiments, the network may send a sounding reference signals (SRS) configuration to the UE 110 for data collection purposes. It should be understood that the SRS configuration is still for use in training a CSI compression model due to correlations between measured SRS and CSI-RS.

In 710, the gNB 120A transmits an SRS configuration to the UE 110. It should be understood that similar to the discussion above for the normal and training CSI-RS, this SRS configuration may vary in one or more characteristics compared to “normal” SRS. This “training” SRS may be a separate configuration for data collection purposes, have a longer SRS periodicity, be enabled for both time division duplexing (TDD) and frequency division duplexing (FDD), etc. The UE 110 may transmit SRS via each transmission antenna of the UE to ensure phase coherence between transmission antennas for each SRS transmission.

In 720, the UE 110 transmits SRS to the gNB 120A for each of its antenna ports according to the received SRS configuration 710. While four transmissions are shown for 720, this is only example and other numbers of antennas are possible. In 730, the gNB 120A measures the SRS received from the UE 110.

As described above, in these example embodiments the data is being collected for type 1 training at the network-side. Thus, the gNB 120A (or other network component) may then use the SRS measurements to train one or more CSI compression models. As stated above, there may be a correlation in a channel between SRS measurements and CSI-RS measurements. This correlation may be used when training the CSI compression models.

Turning now to type 2: joint training of a two-sided model at both the network side and the UE side, a second aspect of the example embodiments is described. The second aspect relates to scenarios in which the UE and network train an AI model together. In type 2 scenarios, model information passes between the UE and the network during each iteration. The training data has two parts: an input dataset that is used by the UE; and an output dataset and a set loss function that is used by the network.

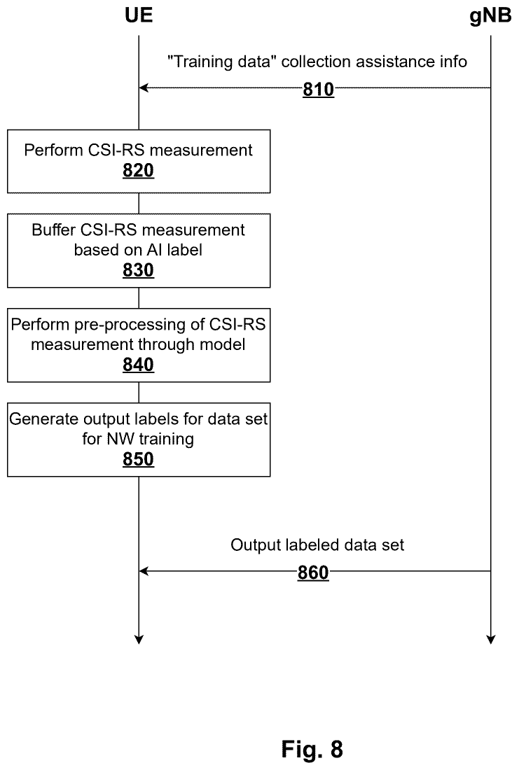

FIG. 8 shows a first call flow for data collection and joint training at the UE and network-side, according to various example embodiments. FIG. 8 may be understood to describe a first option of the second aspect. In the first option, the UE 110 collects the measurements and sends a labeled CSI-RS output data set for training to the network.

In 810, the gNB 120A sends assistance information for collection of training data to the UE 110. The assistance information 810 may include an AI label and/or a CRI-RS configuration. This assistance information 810 may be, for example, the assistance information sent in 410 or 510 as described with reference to FIGS. 4 and 5, respectively, above.

In 820, the UE 110 performs the CSI-RS measurements. In 830, the UE 110 buffers the CSI-RS measurements based on the received label from 810. In 840, the UE 110 performs pre-processing of the CSI-RS measurements. This processing may be understood to represent the UE-side of the two-sided training inherent to type 2 scenarios. In this example, the pre-processing may include labeling each of the CSI-RS measurement results that are to be sent to the network.

In 860, the UE 110 transmits the labeled output dataset to the gNB 120A. The transmission 860 could be the pre-processed measurements 840, a dominant eigenvector of the measurement results, or some combination of the aforementioned.

As described above, the network will receive the labeled output dataset and apply a set loss function to further train the CSI compression model(s).

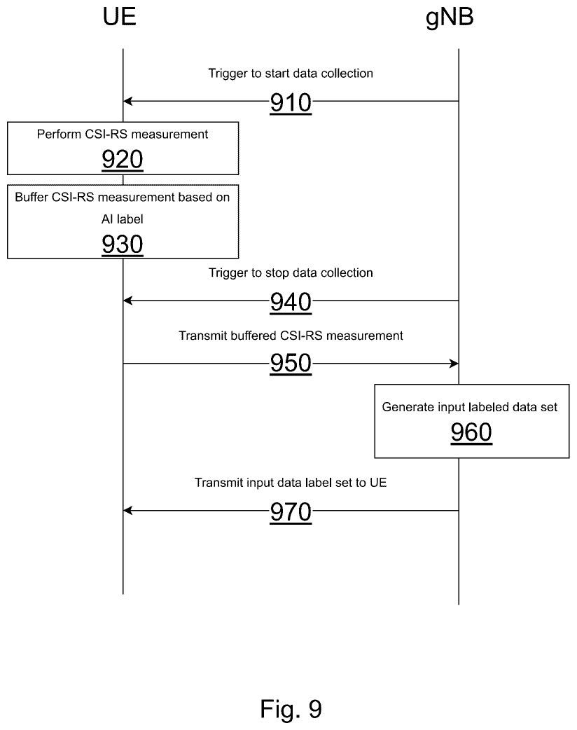

FIG. 9 shows a second call flow for data collection and joint training at the UE and network-side, according to various example embodiments. FIG. 9 may be understood to describe a second option of the second aspect. In the second option, the network may collect the measured CSI-RS from the UE 110 and transmit a labeled CSI-RS input data set for training back to the UE 110. FIG. 9 will be described with a CSI-RS collection scheme substantially similar to that described in FIG. 6. However, it should be understood that the CSI-RS need not be buffered (e.g., the measurements may be contemporaneously transmitted back) or the UE 110 may instead transmit SRS to the gNB as described with respect to FIG. 7.

Operations 910-950 proceed in a substantially similar manner to that described for operations 610-650, respectively, as shown in FIG. 6. In 960, the gNB 120A generates an input labeled data set for training at the UE 110. In 970, the gNB 120A transmits the labeled data set to the UE 110. The UE 110 may then use the labeled data set for CSI compression model training.

In some example embodiments, the UE 110 may represent a UE-side server where data from multiple UEs may be aggregated to generate a composite data set and output labels.

Turning to the third aspect of the example embodiments, an improved means of handling data collection in type 3 split training scenarios is disclosed. In the third aspect, the UE may perform joint training (encode/decode) on a dataset. The UE may perform encode/decode model training offline, to generate an intermediate dataset. The intermediate dataset may be understood to be the encoder/decoder outputs after being run through a training model. The UE may then transmit the intermediate dataset to the network for model training purposes.

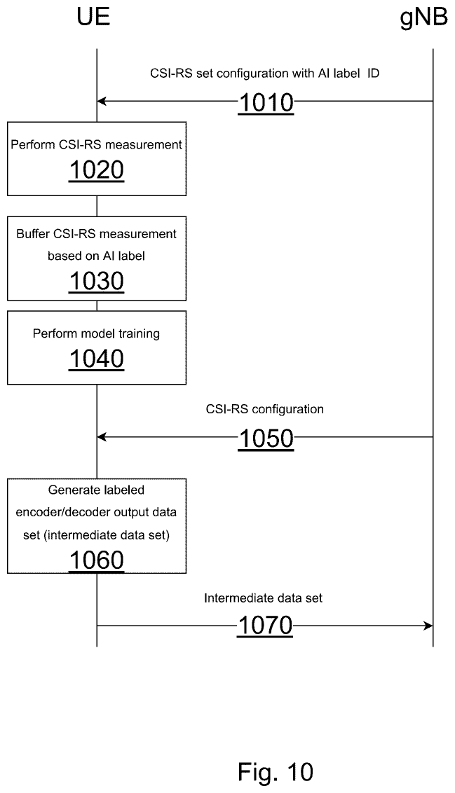

FIG. 10 shows a first call flow for split training occurring at the UE first, according to various example embodiments. FIG. 10 may be understood to describe a first option of the third aspect. The UE may collect training assistance information in a manner substantially similar to that described in FIGS. 4-5. FIG. 10 includes operations substantially similar to those described in FIG. 4 (i.e., 1010-1030 correspond to 410-430), but it should be understood that any of the previously described operations for CSI-RS set configuration or SRS configurations sent to the UE may be used instead.

In 1040, the UE 110 performs offline (e.g., with no assistance from the network) encode and decode model training. In 1050, the gNB 120A transmits a CSI-RS set configuration for intermediate data set generation. For clarity, in 1050, the UE 110 has already performed offline modeling. Upon receiving the CSI-RS set configuration 1050, the UE 110 may further act upon the modeled data set.

In 1060, the UE 110 uses the received CSI-RS set configuration 1050 and offline modeled data set 1040 to generate a labeled encoder/decoder output data set. This labeled data set 1060 may also be understood as an intermediate data set. This labeled data set may be used by the network for training purposes.

In 1070, the UE 110 transmits the intermediate data set to the gNB 120A. The UE 110 may transmit the intermediate data set as a buffered payload via PUSCH, or the UE 110 may transmit per-CSI-RS measurements as UCI to the gNB 120A.

There are additional options possible for operation 1070. The UE 110 may feature a neural network (NN) encoder and a quantizer both included in the labeled encoded output. The gNB 120A (network) may feature a NN decoder and de-quantizer. The NN encoder may be used as a NN output, the quantizer may be used as a quantizer output, and the NN decoder may be used as a decoder output. One of skill in the art will recognize that these inputs and outputs may be arranged in several ways to train a model. For example, the NN output may be used as an input to a model and the quantizer output may be used as a desired output to a model.

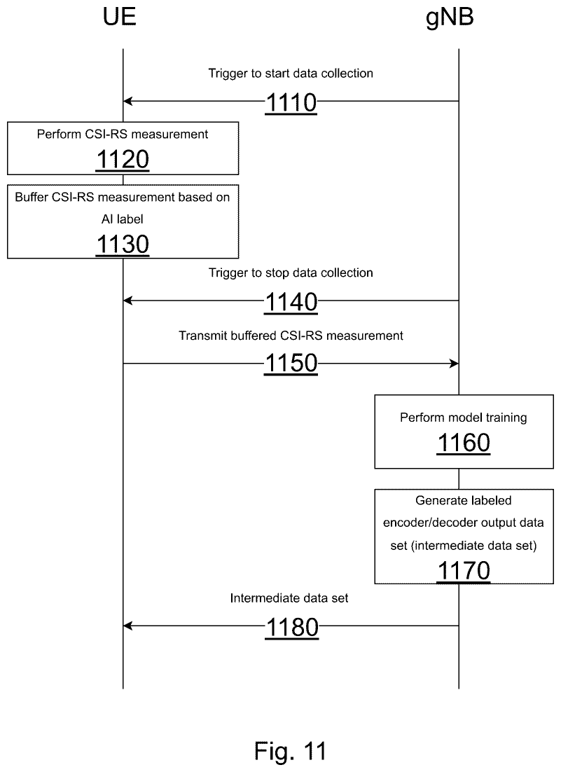

FIG. 11 shows a second call flow for split training occurring at the network first, according to various example embodiments. FIG. 11 may be understood to describe a second option of the third aspect. It should be understood that the network may collect training assistance information in a manner substantially similar to that described in FIGS. 6-7. FIG. 11 includes operations substantially similar to those described in FIG. 6 (i.e., 1110-1150 correspond to 410-450), but it should be understood that any of the previously described operations for CSI-RS set configuration or SRS configurations sent to the UE may be used instead.

In 1160, the gNB 120A performs offline model training based on the received CSI-RS measurements from the UE 110. In 1170, the gNB 120A generates a labeled encoder/decoder output data set (e.g., an intermediate data set). In 1180, the gNB 120A transmits the entire intermediate data set to the UE 110, including the labeled encoder inputs and labeled encoder outputs for UE-side encoder training.

### EXAMPLES

In a first example, a method performed by a base station, comprising sending a training channel state information reference signal (CSI-RS) configuration comprising assistance information to a user equipment (UE), wherein the assistance information comprises an AI label for training CSI-RS to be measured, sending a start indication to the UE to prompt the UE to start measuring the training CSI-RS and receiving, from the UE, a measurement report comprising measurement results for the training CSI-RS.

In a second example, the method of the first example, further comprising sending a stop indication to the UE to prompt the UE to stop measuring the training CSI-RS.

In a third example, the method of the second example, wherein the measurement report is received after the sending of the stop indication.

In a fourth example, the method of the third example, wherein the measurement report is received via a Physical Uplink Shared Channel (PUSCH).

In a fifth example, the method of the third example, wherein the measurement report comprises a plurality of measurement reports that are received prior to the sending of the stop indication.

In a sixth example, the method of the fifth example, wherein the measurement report is received via uplink control information (UCI).

In a seventh example, the method of the first example, wherein the training CSI-RS configuration and start indication are transmitted via a same message.

In an eighth example, the method of the first example, wherein the assistance information further comprises a number of bits per value, a channel or an eigen vector for the CSI-RS.

In a ninth example, the method of the first example, wherein the measurement report further comprises a labeled output data set based on at least the CSI-RS measurements and AI label, the method further comprising training a CSI compression model based on the labeled output data set.

In a tenth example, the method of the first example, further comprising generating a labeled input data set based on at least the measurement results and AI label and transmitting the labeled input data set to the UE.

In an eleventh example, the method of the first example, further comprising training an encoder model and a decoder model for processing CSI-RS, processing the measurement results using the encoder model and decoder model to generate a labeled dataset for the measurement results and transmitting the labeled dataset, the encoder input, and decoder output to the UE.

In a twelfth example, the method of the first example, wherein the measurement results further comprise a labeled dataset based on at least the AI label, an encoder input corresponding to the AI label and a decoder output corresponding to the AI label.

In a thirteenth example, the method of the first example, wherein the AI label comprises an AI model identification (ID).

In a fourteenth example, a processor configured to perform any of the methods of the first through thirteenth examples.

In a fifteenth example, a base station comprising a transceiver configured to communicate with a user equipment (UE) and a processor communicatively coupled to the transceiver and configured to perform any of the methods of the first through thirteenth examples.

In a sixteenth example, a method performed by a base station, comprising sending a training sounding reference signal (SRS) configuration to a user equipment (UE), wherein the training SRS configuration comprises training SRS that are to be transmitted via each transmission antenna, receiving, from each antenna of the UE, training SRS, measuring the training SRS and training a CSI compression model based on the training SRS measurements.

In a seventeenth example, the method of the sixteenth example, wherein the training SRS configuration comprises a time division duplex (TDD) configuration or a frequency division duplex (FDD) configuration.

In an eighteenth example, a processor configured to perform any of the methods of the sixteenth through seventeenth examples.

In a nineteenth example, a base station comprising a transceiver configured to communicate with a user equipment (UE) and a processor communicatively coupled to the transceiver and configured to perform any of the methods of the sixteenth through seventeenth examples.

In a twentieth example, a method performed by a user equipment (UE), comprising receiving a training channel state information reference signal (CSI-RS) configuration comprising assistance information, wherein the assistance information comprises an AI label for training CSI-RS to be measured, measuring the training CSI-RS based on the CSI-RS configuration and sending, to a network, a measurement report comprising measurement results for the training CSI-RS.

In a twenty first example, the method of the twentieth example, further comprising receiving, from the network, a start indication to begin measuring the training CSI-RS.

In an twenty second example, the method of the twenty first example, wherein the training CSI-RS configuration and start indication are received in a same message.

In a twenty third example, the method of the twenty first example, further comprising receiving, from the network, a stop indication to stop measuring the training CSI-RS.

In a twenty fourth example, the method of the twenty third example, further comprising buffering the measurement results for the training CSI-RS based on the AI label, wherein the measurement report is sent after receiving the stop indication.

In a twenty fifth example, the method of the twenty fourth example, wherein the measurement report is sent via a Physical Uplink Shared Channel (PUSCH).

In a twenty sixth example, the method of the twenty fourth example, wherein the measurement report comprises a plurality of measurement reports that are sent prior to receiving the stop indication.

In a twenty seventh example, the method of the twenty sixth example, wherein the measurement reports are sent via uplink control information (UCI).

In a twenty eighth example, the method of the twentieth example, wherein the assistance information further comprises a number of bits per value, a channel or an eigen vector for the CSI-RS.

In a twenty ninth example, the method of the twentieth example, further comprising generating a labeled output data set based on at least the measurement results and AI label and transmitting the labeled output data set to the network.

In a thirtieth example, the method of the twentieth example, further comprising receiving a labeled output data set based on at least the measurement results and AI label from the network and training a CSI compression model based on the labeled output data set.

In a thirty first example, the method of the twentieth example, further comprising training an encoder model and a decoder model for processing CSI-RS, processing the measurement results using the encoder model and decoder model to generate a labeled dataset based on at least the measurement results and the AI label and transmitting the labeled dataset, the encoder input and decoder output to the network.

In a thirty second example, the method of the twentieth example, further comprising receiving a labeled dataset, an encoder input and a decoder output and training a CSI compression model based on the labeled dataset, encoder input and decoder output.

In a thirty third example, the method of the twentieth example, wherein the AI label comprises an AI model identification (ID).

In a thirty fourth example, a processor configured to perform any of the methods of the twentieth through thirty third examples.

In a thirty fifth example, a user equipment (UE) comprising a transceiver configured to communicate with a base station and a processor communicatively coupled to the transceiver and configured to perform any of the methods of the twentieth through thirty third examples.

In a thirty sixth example, a method performed by a user equipment (UE), comprising receiving a training sounding reference signals (SRS) configuration from a network, wherein the training SRS configuration comprises training SRS that are to be transmitted via each transmission antenna and transmitting training SRS based on the training SRS configuration.

In a thirty seventh example, the method of the thirty sixth example, wherein the training SRS configuration comprises a time division duplex (TDD) configuration or a frequency division duplex (FDD) configuration.

In a thirty eighth example, a processor configured to perform any of the methods of the thirty sixth through thirty Seventh examples.

In a thirty ninth example, a user equipment (UE) comprising a transceiver configured to communicate with a base station and a processor communicatively coupled to the transceiver and configured to perform any of the methods of the thirty sixth through thirty seventh examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. In a further example, the example embodiments of the above-described method may be embodied as a program containing lines of code stored on a non-transitory computer readable storage medium that, when compiled, may be executed on a processor or microprocessor.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a base station, the apparatus comprising processing circuitry configured to:
configure transceiver circuitry to send a training channel state information reference signal (CSI-RS) configuration comprising assistance information to a user equipment (UE), wherein the assistance information comprises an AI label for training CSI-RS to be measured;
configure transceiver circuitry to send a start indication to the UE to prompt the UE to start measuring the training CSI-RS; and
decode, based on signals received from the UE, a measurement report comprising measurement results for the training CSI-RS.

2. The apparatus of claim 1, wherein the processing circuitry is further configured to:
configure transceiver circuitry to send a stop indication to the UE to prompt the UE to stop measuring the training CSI-RS.

3. The apparatus of claim 2, wherein the measurement report is received after the sending of the stop indication.

4. The apparatus of claim 3, wherein the measurement report comprises a plurality of measurement reports that are received prior to the sending of the stop indication.

5. The apparatus of claim 1, wherein the training CSI-RS configuration and start indication are transmitted via a same message.

6. The apparatus of claim 1, wherein the assistance information further comprises a number of bits per value, a channel or an eigen vector for the CSI-RS.

7. The apparatus of claim 1, wherein the measurement report further comprises a labeled output data set based on at least the CSI-RS measurements and AI label, wherein the processing circuitry is further configured to:
train a CSI compression model based on the labeled output data set.

8. The apparatus of claim 1, wherein the processing circuitry is further configured to:
generate a labeled input data set based on at least the measurement results and AI label; and
configure transceiver circuitry to send the labeled input data set to the UE.

9. The apparatus of claim 1, wherein the processing circuitry is further configured to:
train an encoder model and a decoder model for processing CSI-RS;
process the measurement results using the encoder model and decoder model to generate a labeled dataset for the measurement results; and
configure transceiver circuitry to send the labeled dataset, the encoder input, and decoder output to the UE.

10. The apparatus of claim 1, wherein the measurement results further comprise a labeled dataset based on at least the AI label, an encoder input corresponding to the AI label and a decoder output corresponding to the AI label.

11. An apparatus of a base station, the apparatus comprising processing circuitry configured to:
configure transceiver circuitry to send a training sounding reference signal (SRS) configuration to a user equipment (UE), wherein the training SRS configuration comprises training SRS that are to be transmitted via each transmission antenna, wherein the training SRS configuration comprises a time division duplex (TDD) configuration or a frequency division duplex (FDD) configuration;
decode, based on signals received from each antenna of the UE, training SRS;
measure the training SRS; and
train a CSI compression model based on the training SRS measurements.

12. An apparatus of a user equipment (UE), the apparatus comprising processing circuitry configured to:
decode, based on signals received from a base station, a training channel state information reference signal (CSI-RS) configuration comprising assistance information, wherein the assistance information comprises an AI label for training CSI-RS to be measured;
measure the training CSI-RS based on the CSI-RS configuration; and
configure transceiver circuitry to send to the base station, a measurement report comprising measurement results for the training CSI-RS.

13. The apparatus of claim 12, wherein the processing circuitry is further configured to:
decode, based on signals received from the bas station, a start indication to begin measuring the training CSI-RS.

14. The apparatus of claim 13, wherein the training CSI-RS configuration and start indication are received in a same message.

15. The apparatus of claim 13, wherein the processing circuitry is further configured to:
decode, based on signals received from the base station, a stop indication to stop measuring the training CSI-RS.

16. The apparatus of claim 15, wherein the processing circuitry is further configured to:
buffer the measurement results for the training CSI-RS based on the AI label, wherein the measurement report is sent after receiving the stop indication.

17. The apparatus of claim 15, wherein the measurement report comprises a plurality of measurement reports that are sent prior to receiving the stop indication.

18. The apparatus of claim 12, wherein the assistance information further comprises a number of bits per value, a channel or an eigen vector for the CSI-RS.

19. The apparatus of claim 12, wherein the processing circuitry is further configured to:
generate a labeled output data set based on at least the measurement results and AI label; and
configure transceiver circuitry to send the labeled output data set to the base station.

20. The apparatus of claim 12, wherein the processing circuitry is further configured to:
decode, based on signals received from the base station, a labeled output data set based on at least the measurement results and AI label; and
train a CSI compression model based on the labeled output data set.
